(19) United States
(12) Patent Application Publication
(10) Pub. No.: US 2016/0158659 A1
(43) Pub. Date: Jun. 9, 2016

(54) COMPUTING BASED INTERACTIVE ANIMATRONIC DEVICE

(71) Applicant: Pecoto Inc., Union City, CA (US)

(72) Inventors: Vinay Pradhan, Union City, CA (US); Bhushan Kerur, Union City, CA (US)

(73) Assignee: PECOTO INC., Union City, CA (US)

(21) Appl. No.: 14/850,881

(22) Filed: Sep. 10, 2015

Related U.S. Application Data
(60) Provisional application No. 62/088,669, filed on Dec. 7, 2014.
(60) Provisional application No. 62/089,841, filed on Dec. 10, 2014.

(51) Int. Cl. A63H 13/00; A63H 3/28; B25J 9/16; A63H 3/02

(52) U.S. Cl. CPC A63H 13/005; A63H 3/02; A63H 3/28; B25J 9/1694; Y10S 901/09; Y10S 901/06

(57) ABSTRACT

Using various embodiments, methods, systems, and device for a computing based interactive animatronic device are described. In one embodiment, the animatronic device can connect to a computer network, and has its processing system coupled to an internally located computing electronic device (e.g., a Smartphone, tablet, etc.). In another embodiment, the computing electronic device is externally located, but within a local network of the animatronic device. In yet another embodiment, the computing electronic device is located on a remote computer network. In another embodiment, the computing electronic device can be internally located within the animatronic device, externally located within the same network as the animatronic device, externally located on a remote network, or a combination thereof. In one embodiment, the electronic device has various sensors and has provides the ability to be versatile with many functionalities, while being a companion buddy to the user of the animatronic device.

### CROSS REFERENCE TO RELATED APPLICATIONS

The present application claims priority from U.S. Provisional Patent Application No. 62/088,669 filed on Dec. 7, 2014, and is titled “CLOUD COMPUTING EMPOWERED STUFFED/PLUSH TOY,” and U.S. Provisional Patent Application No. 62/089,841 filed on Dec. 10, 2014, and is titled “SMARTPHONEORELECTRONIC TABLET BASED STUFFED PLUSH TOY,” and the contents of which are incorporated by reference.

### FIELD OF THE INVENTION

Embodiments of the present invention relates generally to the field of animatronic devices. More particularly, embodiments of the invention relate to computing toys that can interact with the user by connecting the user to the internet using a Smartphone, mini-computer, or any data processing device.

### BACKGROUND OF THE INVENTION

Plush toys, also known as companion toys, like teddy bears are sometimes referred to as comfort toys as they can provide stress relief to the holder of such toy. However, such toys are inanimate or provide limited functionality, and interact with the user only based on their built in programming capacity.

Although with advances in technology, such comfort toys have the ability to connect to the internet, their functionality still remains deeply limited. Thus, what is needed are computing based interactive animatronic devices that are versatile and can provide a user a wide variety of functionalities while providing being a comfort toy.

### SUMMARY OF THE DESCRIPTION

In one embodiment, an animatronic device/toy is configured as a stuffed toy, and comprises a plurality of sensors, including at least an audio sensor, a visual sensor, a proximity sensor, olfactory sensor, or a touch sensor. In another embodiment, the animatronic device can be ‘network-enabled’, that is, it is capable of connecting to the internet or a remote computer network via a wireless module device. In one embodiment, the animatronic device also comprises an audio transmitting module; a moveable appendage located on a face portion of the stuffed toy, the movable appendage is configured to imitate a lip like structure. The animatronic device further comprises at least one electro-mechanical device/actuator such as a servomotor or a magnetic actuator, coupled to the moveable appendage; the actuator can control mechanical movements of the moveable appendage. Further, the animatronic device comprises a data processing unit or system that includes at least one processor. The data processing system of the animatronic device is configured to receive a signal from the sensors of the animatronic device, the signal is generated due to a verbal, visual, proximity based, touch based, or odor based command, depending on the corresponding sensor transmitting the signal. The processing system then processes the signal to generate an instruction that is transmitted to a second data processing unit or system (e.g., Smartphone, tablet, desktop Personal Computer (PC), cloud computing unit, remotely networked server, etc.). In one embodiment, the second data processing system can be internally located within the animatronic device or it can be externally located. The data processing unit/system of the animatronic device then receives a response (in the form of an audible transmission) from the other (internal or external) processing unit/system. In another embodiment, the response can also be a non-verbal communication which translates in the movement of an actuator of the animatronic device.

Based on the response, the data processing system of the animatronic device controls an actuator of the animatronic device to generate mechanical movements in any moveable joint or appendage of the animatronic device (e.g., jaw, lips, eyes neck, arms, legs, etc.). In another embodiment, the second data processing system can be located within the animatronic device or can be externally located. In yet another embodiment, the actuator located near the movable lip like appendage is a servomotor. In one embodiment, an actuator or servomotor can be configured to head movement, eye movement, arm movement, or leg movement of the animatronic device.

In one embodiment, the Smartphone is enclosed within the animatronic device, and the sensors within the Smartphone are used by the animatronic device. In another embodiment, the data processing system of the animatronic device is capable of synchronizing an audio transmission along with the mechanical movements of the moveable appendage using an actuator. In another embodiment, the synchronization commands of the actuator are transmitted by the other data processing system (whether internally or externally located) along with the audible commands (if any). Thus, in this manner the internal processing power required by the animatronic device can be managed. In one embodiment the second data processing unit/system communicates with the data processing unit of the animatronic device using a micro-Universal Serial Bus (micro-USB) interface located on the second data processing unit/system.

In yet another embodiment, the sensors of the animatronic device further includes gyroscope(s), air pressure sensor(s), orientation sensor(s), geo-location or GPS sensor(s), and temperature sensor(s). In one embodiment, the proximity sensors include infrared or ultrasound sensor(s). In yet another embodiment, the second data processing unit/system can be a computing device within the same network as the animatronic device, and can communicated with an external web-based (or cloud based) computing system. Thus, in such an embodiment, based on the signal received from the data processing unit of the animatronic device, the second data processing system can transmit an instruction, over a computer network, to a cloud based on internet based remote server, receive a response, and transmit the response to the processing system of the animatronic device. In another embodiment, the processing system of the animatronic device and the second data processing unit can communicate using a wireless communication protocol. In another embodiment, the second data processing unit is located within the same network as the animatronic device. In one embodiment, the second data processing unit is located on a remote network.

### BRIEF DESCRIPTION OF THE DRAWINGS

The present invention is illustrated by way of example and not limitation in the figures of the accompanying drawings in which like references indicate similar elements.

FIG. 1 illustrates an animatronic device with an electronic device compartment, according to one embodiment of the present invention.

FIG. 2 illustrates an electronic device compartment when opened, according to one embodiment of the present invention.

FIG. 3 illustrates an electronic device compartment with an electronic computing device attached to it, according to one embodiment of the present invention.

FIG. 4 illustrates the frame and components of the animatronic device, according to one embodiment of the present invention.

FIG. 5 illustrates the sensors of the animatronic device, according to an embodiment of the present invention.

FIG. 6 illustrates the system architecture of the animatronic device, according to an embodiment of the present invention.

FIG. 7 illustrates the structure and components of the animatronic device, according to anther embodiment of the present invention.

FIG. 8 illustrates the system architecture of the animatronic device, according to another embodiment of the present invention.

FIG. 9 describes a block diagram illustrating a computing system that can be used with any computing device in various embodiments, as discussed in the innovative subject matter.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” or “another embodiment” means that a particular feature, structure, or characteristic described in conjunction with the embodiment can be included in at least one embodiment of the invention. The appearances of the phrase “in one embodiment” in various places in the specification do not necessarily all refer to the same embodiment. The processes depicted in the figures that follow are performed by processing logic that comprises hardware (e.g., circuitry, dedicated logic, etc.), software, or a combination of both. Although the processes are described below in terms of some sequential operations, it should be appreciated that some of the operations described can be performed in a different order. Moreover, some operations can be performed in parallel rather than sequentially.

Disclosed herein are systems, methods, and devices that can use a Smartphone/tablet or any general computing device with an animatronic device (electronic toy) in the form of any user familiar object or toy, including a cute, cuddly, and appealing stuffed/plush toy, a doll or an action figure. In various embodiments, the computing device associated with the animatronic device can be located internally (inside) the animatronic device, or could be located externally (outside). In one embodiment, the computing device provides processing power (local or external) and also makes use of voice recognition and synthesis. In one embodiment, an external microphone and speaker(s) can form the audio interface. In another embodiment, the computing devices speakers/microphone are used.

In one embodiment, verbal communication is the primary user interface for the user familiar animatronic device. The animatronic device can also provide text to speech synthesis and facilitate use of several relevant software applications (e.g., ‘mobile apps’, etc.). The animatronic device can access web resources on the internet to provide requested information and also to substitute or augment limited local processing power of the computing device (e.g., Smartphone/tablet).

In one embodiment, widespread availability of fast wireless broadband access and powerful cloud computing resources can be utilized to accomplish tasks that would be beyond the capability of any local computing (e.g., onboard microprocessor). This enhanced processing capability can allow several desired processing intensive tasks including voice and facial recognition.

In an embodiment, the animatronic device can be a personal digital assistant that can take and play messages, setup alarms and reminders, greet and interact with people through its ability of voice and face recognition. In one embodiment, the user interacts with the animatronic device through voice command and query. It can enable verbal web queries in place of typing the same on a laptop or a phone. In another embodiment, the animatronic device can have speech synthesis and text to speech capabilities for providing query results, for holding verbal dialog or rather interacting with people. In yet another embodiment, the animatronic device can play internet radio on command, tell stories, play quizzes, play music, relay weather forecast, say find out which movies are playing where (using its Global Positioning System (GPS) feature for location) or suggest a restaurant. In yet another embodiment, the animatronic device can place voice calls using Voice over Internet Protocol (VoIP) functionality. In another embodiment, the animatronic device disclosed herein can be used as a baby monitor.

In one embodiment, the animatronic device discloses herein has electronic sensors such as Touch, Ultrasound proximity, Infrared proximity/motion, or smell (olfaction device). Such sensors can be located on the animatronic device itself or are available in the computing device (e.g., Smartphone/tablet). When the sensors are located on the animatronic device, the built-in computing devices sensors (e.g., Smartphone/tablet sensors) can supplement the existing sensors of the object toy. Thus, sensors that are already located on a Smartphone/Tablet such as accelerometers, gyroscopes, orientation, pressure, temperature, sound, light etc. can be used to supplement the sensors of the animatronic device. In one embodiment, sensor interfaces could be analog or digital (e.g., I²C/I2C bus). In one embodiment, any required mechanical motion is provided by electro-mechanical devices/actuators such as servo(s) or magnetic actuators.

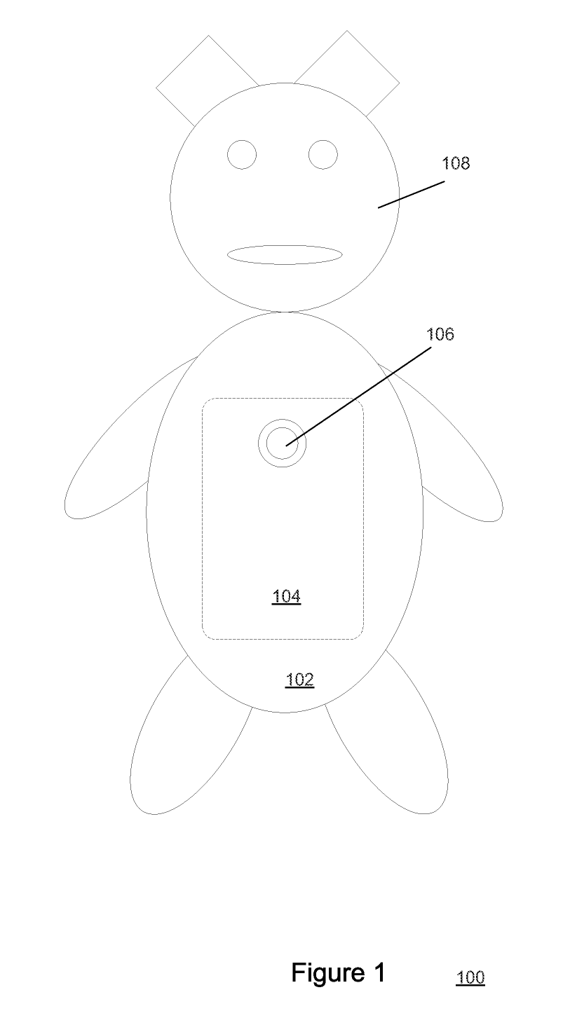

FIG. 1 illustrates an animatronic device with an electronic device compartment, according to one embodiment of the present invention. As illustrated, animatronic device 100 can have a body portion 102, having an electronic device compartment 104, and face portion 108. In one embodiment, electronic device compartment 104 can have a camera opening 106 for a camera built into the electronic device. In one embodiment, electronic device can be a Smartphone or a tablet, and camera opening 106 can be configured as an opening for the built-in camera of the Smartphone or tablet.

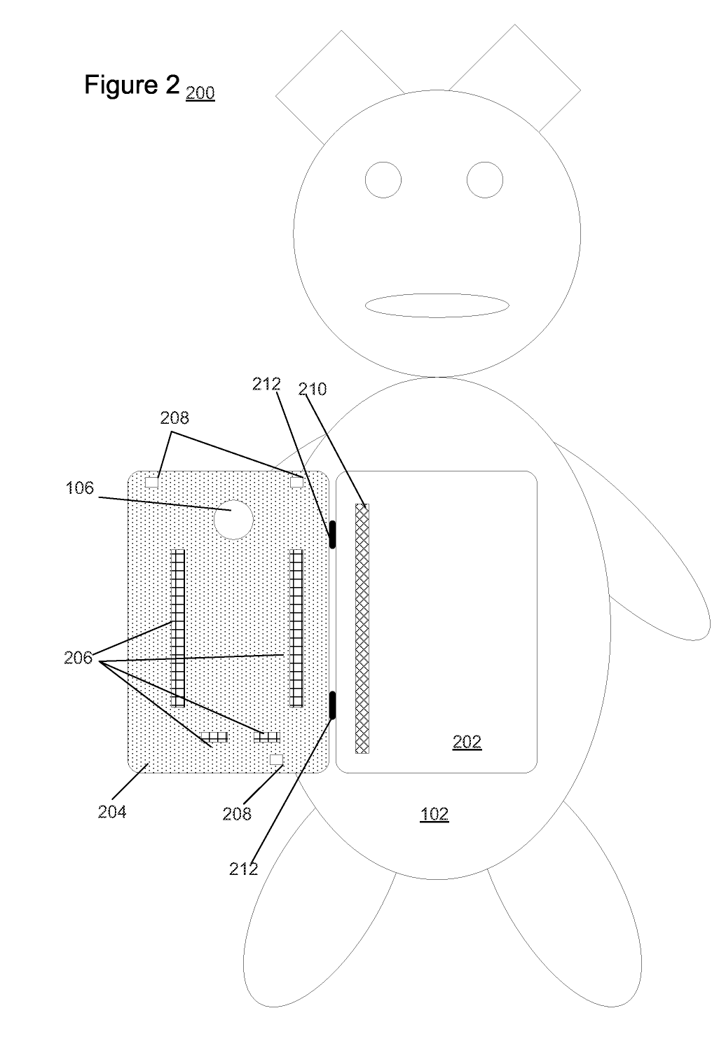

FIG. 2 illustrates diagram 200 in which an animatronic device with an electronic device compartment, when opened, according to one embodiment of the present invention.

In one embodiment, electronic device access port hatch or compartment 104 can be configured at the front of animatronic device 100. Compartment 104 is configured to have an outside cover or door 204 and a cavity section 202. As illustrated, electronic device compartment 104 is located on body 102 and is shown when the compartment door 204 is opened. Cavity section 202, in one embodiment, can accommodate an electronic device (e.g., Smartphone, tablet, small computer, etc.). For example, door 204 can be opened for a Smartphone insertion and removal or just to access the Smartphone for setup or rebooting. In one embodiment, compartment door 204 is coupled to cavity section 202 using hinges 212, as illustrated. In one embodiment, to close or lock compartment 104, compartment door 204 can be secured with a latch(es) or screw(es) (not shown) to cavity section 202. In one embodiment, such latch(es) or screw(s) can be configured to be placed on the opposite side from hinges 212.

In one embodiment, door 204 comprises adjustable side guiding rails 206 that can be loosened and an electronic device can be inserted between guiding rails 206. In one embodiment guide rails are provided on the side and bottom portions of door 204, as illustrated. In one embodiment, the electronic device (e.g., Smartphone) orientation is such that a camera of the electronic device faces the user with camera lens pointing the user via camera port 106. Thus, in case of a Smartphone having a built-in Camera lens at the rear or backside of the device, the Smartphone screen will be facing inwards towards cavity 202. Guiding rails 206 can be adjusted to fit snuggly against the Smartphone and optionally secured with screws (not shown) to hold the Smartphone in place. Compartment 104 can also have an open or transparent camera port 106 to let the Smartphone rear camera have an unobstructed outside view. In yet another embodiment, camera port 106 is configured to let an unobstructed outside view of an external camera (that is, not the Smartphone Camera).

In one embodiment, the electronic device communicates with the electronic components of animatronic device 100 by using wires. In such an embodiment, clips 208 can be introduced to support such wires. Thus, clips 208 can be used to create a clutter free environment. Wiring panel 210 can also be introduced, in one embodiment, where the wiring panel acts as an interface that connects/routes/guides the wires between the electronic device and the electronic components/systems of animatronic device 100.

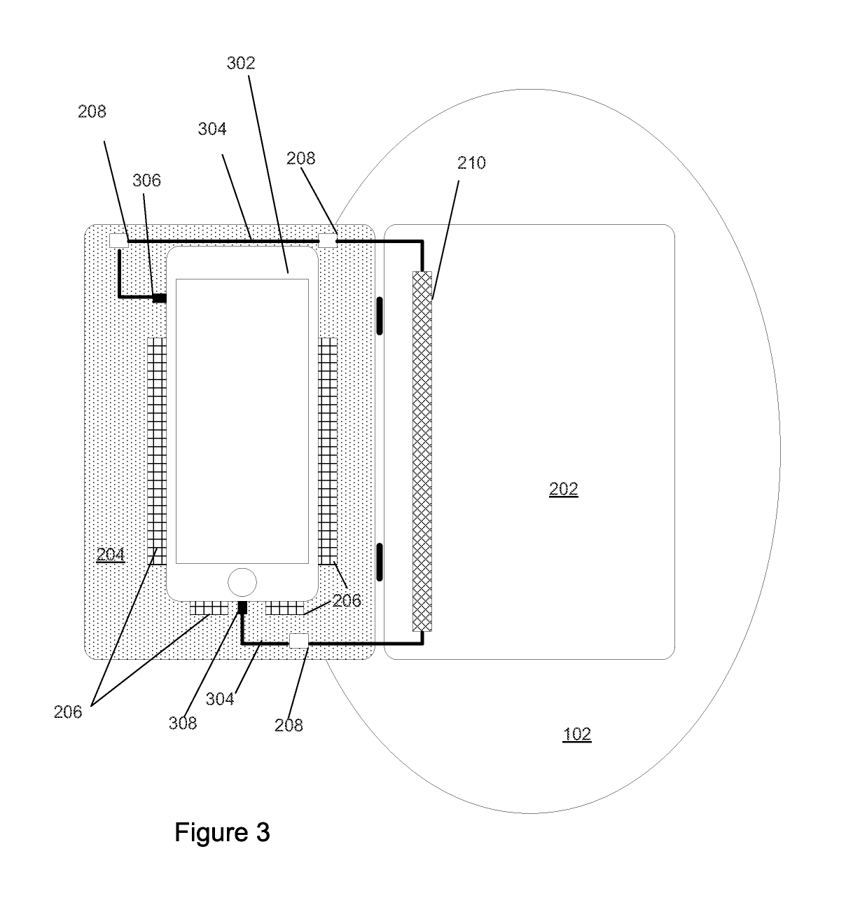

FIG. 3 illustrates diagram 300 with an electronic device compartment using a Smartphone attached to it, according to one embodiment of the present invention. As illustrated, animatronic toy body 102 with compartment door 204 and cavity 202 are shown. Cavity 202 is big enough to completely allow Smartphone 302 fit in. Smartphone 302 is secured to the inside of the compartment door 204 using guard rails 206. Connection wires 304 connect wiring panel 210 to connect Smartphone 302 with two or more connection points. In one embodiment, one connection point is near the top at the top inside of compartment door 204 from where a headphone interface 306 connects with a port in Smartphone 302, and another connection point connects connection wire 304 at the bottom of compartment door 204 using a Micro Universal Serial Bus (micro-USB) interface 308. Connection wires 304 are secured using clips 208. As illustrated these connections are routed through wiring panel 210 to interface with Smartphone 302. The (bottom) micro USB connection socket 308 is inserted into the Smartphone micro USB port and the (top) headphone connection socket 306 is inserted into the headphone port of Smartphone 302. In one embodiment, the micro USB connection 308 delivers power and provides communications link with a servo controller (not shown) of animatronic device 100. The other end of the headphone port connection (away from Smartphone 302) connects to an amplifier board (not shown) from wiring panel 210, from where is can be connected to an external speaker and a microphone(s). In one embodiment, the speaker and the microphone(s) can be located at any appropriate location on the device for audio clarity. Once it is ensured that the Smartphone power is on and the setup (including Wi-Fi) is complete, compartment 104 can be closed and secured (using the latch(es)/screw(s) discussed above) for operation of animatronic device 100.

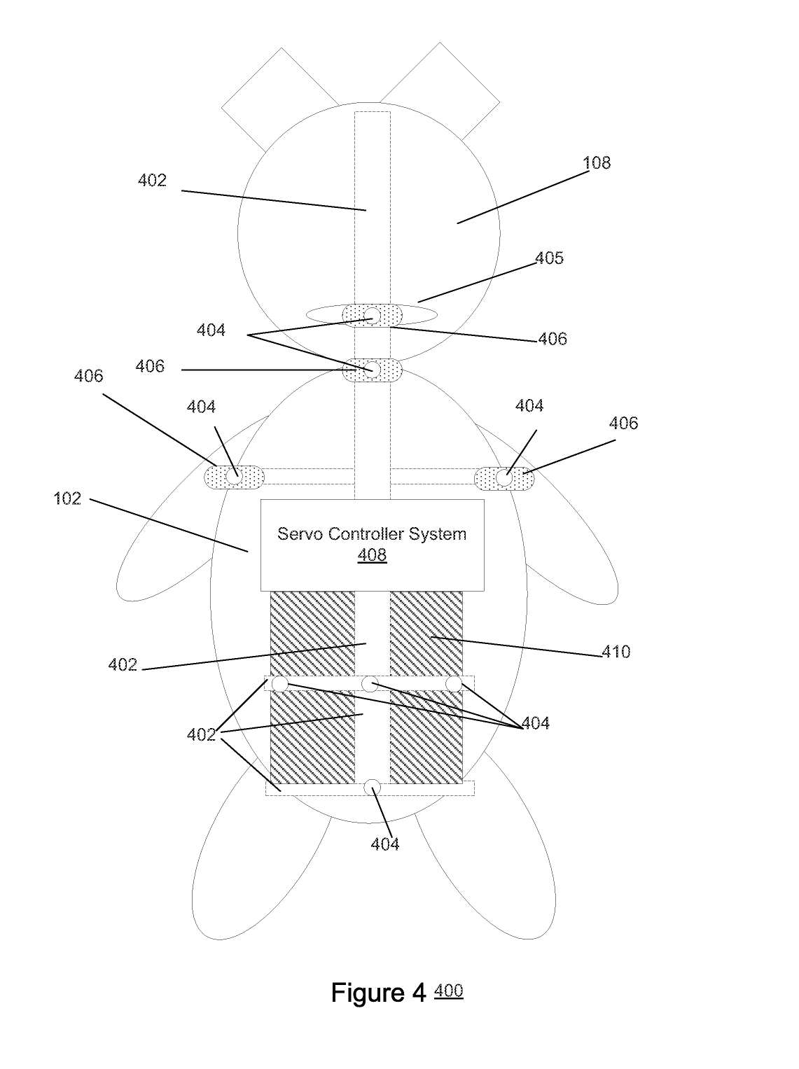

FIG. 4 illustrates diagram 400 illustrating the mechanical frame and electronic components of the animatronic device, according to one embodiment of the present invention. In one embodiment, a mechanical frame 402 can provide support for all required electronic components inside the animatronic device. Actuator/motor (e.g., servomotor) 406 can be configured to be at the face portion 108 on mechanical frame 402 of the animatronic device to provide mechanical movement to a movable appendage 405 that is configured as a lip or lower jaw of the animatronic device. In one embodiment, an actuator can be affixed to mechanical frame 402 using mechanical mountings 404. In another embodiment, actuator 406 can also be provided at the neck area (or joint between the head and body) to provide rotational capacity to the head of the animatronic device. Further, actuator 406 can also be provided at the arm area on mechanical frame 402 to provide arm movement(s). In one embodiment, a servo controller system 408 can be configured to control the actuators or servomotor movements. In another embodiment, the servo controller system can also be affixed to the mechanical frame 402. The animatronic device can also comprise battery compartment 410 into which a battery pack can be inserted. In one embodiment, battery compartment is also affixed to mechanical frame 402. In one embodiment, battery compartment 410 can also comprise clips 208 (not shown) to support/affix any wires that are needed to provide power to the animatronic device. In such an embodiment, clips 208 can be introduced to support such wires. Thus, clips 208 can be configured to generate a clutter free environment in battery compartment 410.

As illustrated, mechanical frame 402 can extend vertically from the body portion to the head portion of the animatronic device. Mechanical frame 402 can extend horizontally (as illustrated) to provide actuators for the arms. Further, mechanical frame 402 can further have horizontal structures to provide support to batter compartment 410. In one embodiment, battery compartment has a built-in non-removable battery pack. In another embodiment, the battery pack can rechargeable. In yet another embodiment, the battery pack is removable. Battery compartment 410 can have two horizontal structures to secure battery compartment 410 to mechanical frame 402.

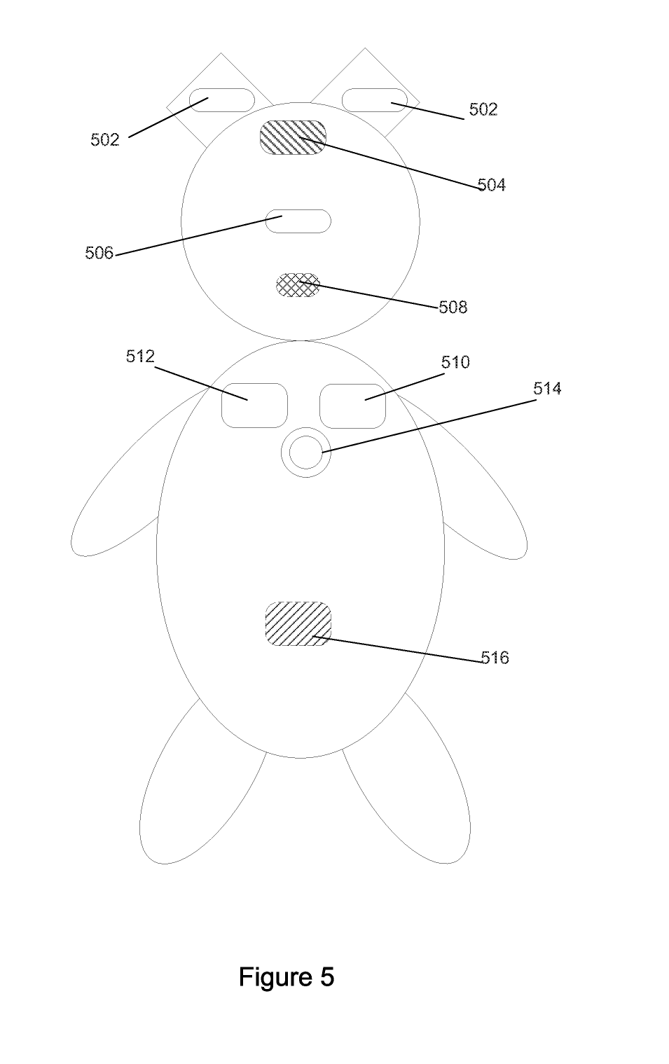

FIG. 5 illustrates the sensors of the animatronic device, according to an embodiment of the present invention. In one embodiment, the animatronic device can have various internal and/or external sensors, like, touch, proximity sensor (e.g., ultrasound proximity, infrared proximity/motion sensor), or smell (olfaction/olfactory device), gyroscope, air pressure sensor, orientation sensor, a geo-location sensor (e.g., GPS), and a temperature sensor. The animatronic device can also have an externally located video camera that is separate from the computing device. As illustrated, the animatronic device can have microphones 502 located on the ears (or any other appropriate location), touch sensor 504 located at the crown position of the animatronic device, olfaction device 506 located near the nose portion, and speaker 508 located at behind the mouth of the animatronic device. In one embodiment, touch sensor 504 is located on the back of a head portion (e.g., back of the crown position, etc.) of the animatronic device. Further, in one embodiment, ultrasound sensor 512 and infrared sensor 510 can also be configured and placed at the top body portion of the animatronic device. Ultrasound and infrared both could be used for object distance and motion determination. Touch sensors of the animatronic device can detect user's touch and is used for various touch sensitive applications. In one embodiment, smell/olfactory sensor(s) can be used for safety reasons such as detecting fire (smoke) or gas smell and warn the user accordingly. In another embodiment, the animatronic device can be configured to automatically contact emergency services (e.g., 911) and/or a predetermined number (using VoIP services), if after repeated warnings the user fails to take action and the sensor(s) continuously detects the presence of smoke or gas in its environment for a predetermined period (e.g., 5 minutes, 10 minutes, 15 minutes, etc.). In one embodiment, the animatronic device can be customized to the user's liking using a configurable profile setting available to the user. In one embodiment, the user can configure a profile (or profile) setting using any computing device that can be in communication with the animatronic device.

Camera 514 can be a standalone camera of the animatronic device, or can be the built-in camera of the electronic device (e.g., rear camera of a Smartphone or tablet, etc.). In one embodiment, camera 514 can use camera port 106 of compartment 104. In one embodiment, touch sensor(s) 516 can be placed at a back body portion (back side of the body position), at a front body portion (front side of the body portion), or a combination thereof, of the animatronic device. It should be noted, the sensor placements discussed herein are for illustrative purposes only, and a person of ordinary skill in the art would appreciate that the sensors can be placed at any appropriate location of the animatronic device, as found necessary during construction of the animatronic device.

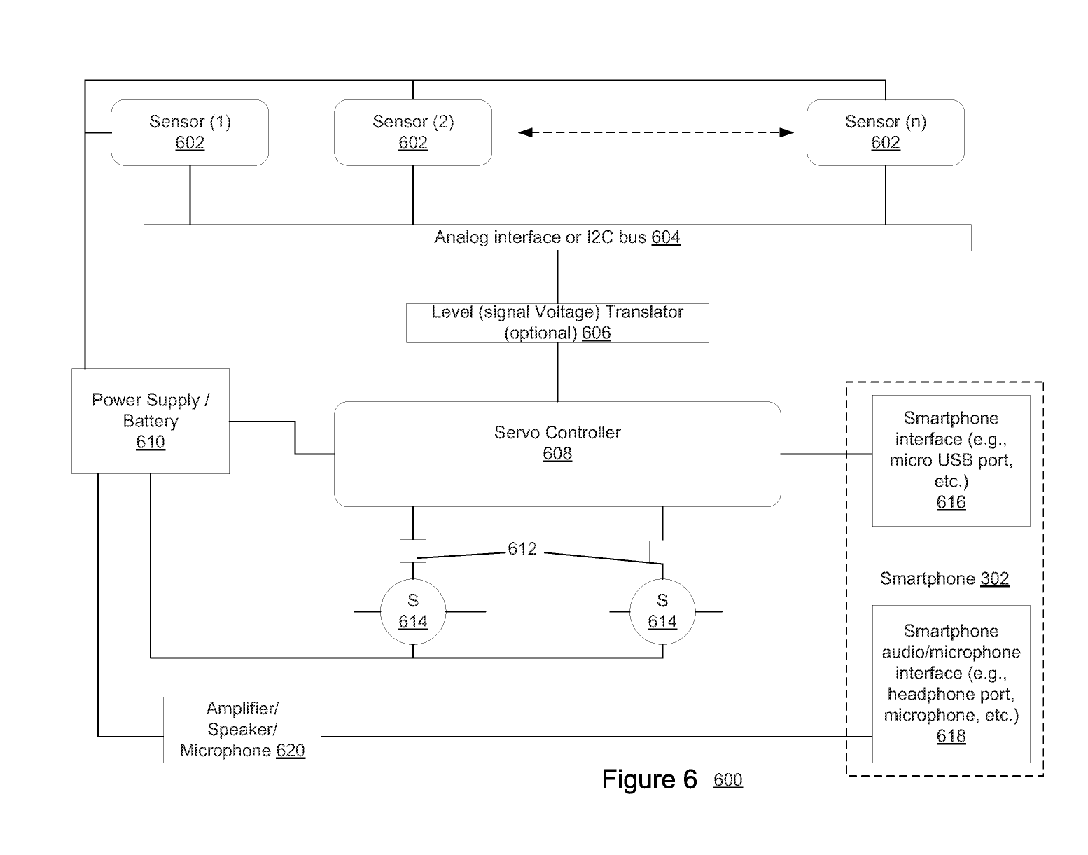

FIG. 6 illustrates the system architecture of the animatronic device, according to an embodiment of the present invention. In this embodiment, it is presumed that Smartphone 302 is placed inside animatronic device 100. Smartphone 302 uses onboard wireless (e.g. Bluetooth) interface for connecting to other external devices if necessary and Wi-Fi (802.3) or cellular (Wi-Fi, 4 G, 3 G, etc.) for connecting to the web resources through a router and fast broadband internet. In one embodiment, Smartphone 302 provides the local computing resources and several sensors including a camera. In this embodiment, Smartphone 302 is physically located as such that its main (rear) camera is pointing out of the animatronic device (e.g., through camera port 106). In another embodiment, an external camera may be used with wired or wireless (e.g. Bluetooth) interface to Smartphone. In one embodiment, the camera assists in providing visual data for face and motion recognition. External speaker(s) and a microphone(s) 620 are connected to Smartphone's audio and/or microphone interface 618 via amplifier 620. Amplifier can be a separate unit or can be built in as illustrated by block 620. A magnetic actuator controller 608 (e.g., servo controller) is used to control magnetic actuators or servo motors (servos) for any required movements of the animatronic device. As disclosed above, the magnetic actuators or servos may be used as an example for arms, limbs, head, mouth/lip, ears, and eyes movements. In one embodiment, servo controller 608 is connected as a slave processor to the Smartphone/tablet via Smartphone interface 616. In another embodiment, servo controller 608 is connected to Smartphone's processor via any appropriate wireless interface (e.g. Bluetooth).

In one embodiment, sensors 602 can be located on the animatronic device. Sensors 602 are interfaced to Smartphone 302 either through a separate interface board or as part of a magnetic actuator controller or a servo controller 608, as illustrated. Sensors 602 can be connected to servo controller 608 using an analog interface or I2C bus 604. Depending on the setup, 604 can represent an analog interface or I2C bus.

In one embodiment, Servo controller 608 acts as a slave processor Smartphone 302 processor. In another embodiment, servo controller 608 provides analog interfacing for the onboard external (not on Smartphone 302) sensors as well as digital outputs for any required tasks (such as eye blinking). In one embodiment, external sensors 602 used in the device with the servo controller 608 can have an analog interface only and no digital interface sensors are used.

A person of ordinary skill would appreciate that there could be one or more servos for the desired mechanical movements, depending on the size, form and the model of the animatronic device. In one embodiment, an optional level translator 606 can be used to transmit the signal generated by sensors 602. Signal voltage level translator 606 can be needed if there is a signal levels mismatch between sensors 602 and servo controller system 608 Level translator interacts with interface 604 to receive the sensor signal, and transmits the signal to servo controller 608. In one embodiment, servo controller 608 provides necessary instructions to servos 614 using servo control interface 612 that transmits the instructions from servo controller 608 to servos 614.

In one embodiment, the processing system of Smartphone 302 handles all the system management tasks, as needed. It interprets the command and can take into account any sensory data from the sensors for decision making, the processing system of Smartphone 302 can also determine if it can act on its own or the particular instance requires assistance from the web or rather specifically from the web based cloud computing servers. If such ‘cloud assist’ functionality is utilized then the processing unit gets the required data and suggested response from the servers. In either case, the local processing unit of Smartphone 302 ultimately decides on the audio and mechanical responses. Response may be either verbal or some other audio (e.g. sound) or selected magnetic actuator/servomotor instigation to execute the required movements, or a combination thereof.

In one embodiment, servo controller system 608 can synchronize servo 614 movements with the audio generated by Smartphone 302. For example, for lip synchronization of servomotor 614 placed near movable appendage, servo controller system 608 can transmit control signals to the respective servo control interface 612 in such a way that the audio transmitted from Smartphone 302 is synchronized with the movement of moveable appendage 405. Similarly, audio response can be synchronized with movements of any servo actuator (e.g., those located on the neck, arms, eyes, etc.).

In one embodiment, all decision making and response generation of the animatronic device is implemented in software (not hardwired) and is totally under software control and can easily be deleted, added, or modified as needed. In one embodiment, power supply/battery 610 can be in the form of single use batteries or may use rechargeable batteries. Incase rechargeable batteries are used, an external AC/DC converter (wall unit) (not shown) can be used along with voltage regulators and a battery charge monitoring circuit. In one embodiment, a system DC (Direct Current) bus delivers appropriate power to various devices. In any embodiment of the animatronic device, discussed herein, an additional (optional) compartment to access the battery compartment can be configured similar to compartment 104.

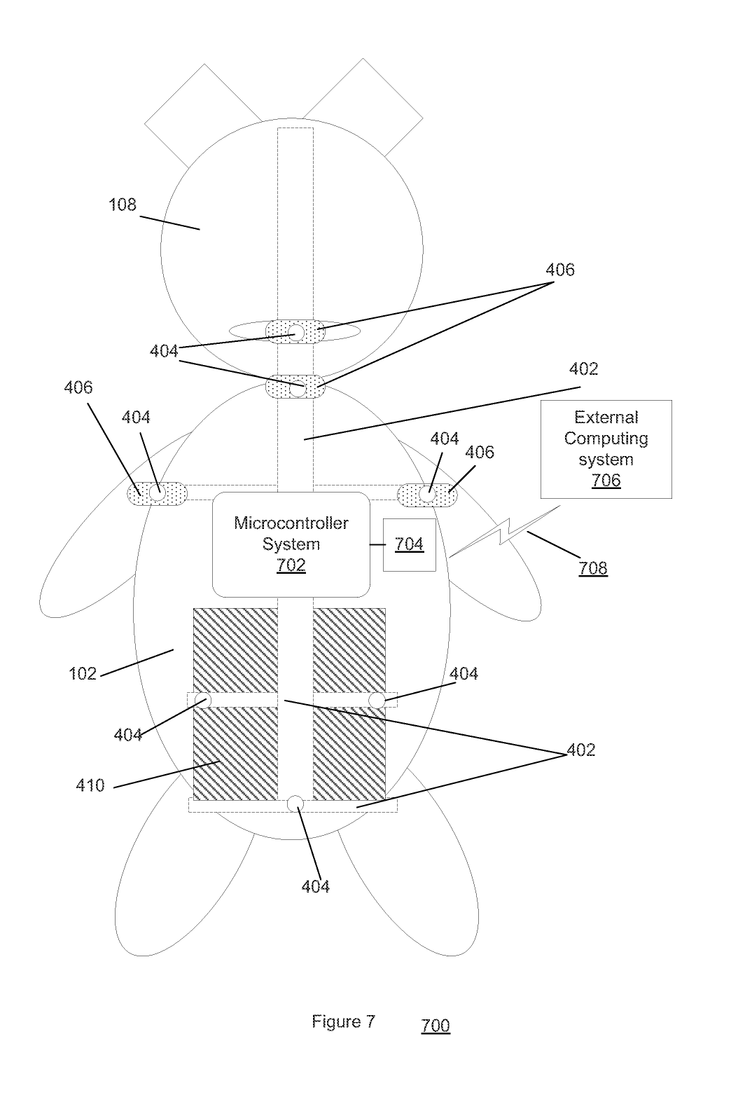

FIG. 7 illustrates diagram 700 disclosing the structure and components of the animatronic device, according to another embodiment of the present invention. In this embodiment, local computing unit is not located in animatronic device 100 device but is located externally as illustrated by block 706. In such a system animatronic device (optionally) does not comprise electronic device compartment 104, since there is no need to insert an electronic device into the animatronic device. In one embodiment, a separate battery compartment is provided to access the battery pack. In this embodiment, an onboard microcontroller system 702 is connected to external computing device 706 via wireless link 708 (e.g. Bluetooth or some other wireless protocol as determined adequate by a person of ordinary skill in the art). In one embodiment, a wireless module 704 (e.g. Bluetooth, Wifi, WiMax, etc.) is attached to the onboard microcontroller (microcontroller system 702). In another embodiment, wireless module 704 is built-in to the microcontroller of system 702. It should be noted, wireless module 704 can be a transceiver using any wireless technology known to a person of ordinary skill in the art. Wireless module 704 delivers the needed wireless link between the microcontroller system 702 and the external computing system 706. Microcontroller system 702 manages the operation of the device for the external computing unit 706. In one embodiment, microcontroller system 702 acts as slave processor to the external computing system 706. In another embodiment, wireless module 704 is a part of microcontroller system 702.

In one embodiment, external computing system 706 could be a Smartphone, tablet, personal computer or laptop with corresponding wireless protocol (e.g. Bluetooth protocol) and is able to control the animatronic device using supporting mobile applications or software(s) as well as a supported speech recognition software package.

In one embodiment, sensor placement is similar to the embodiment with the electronic device located inside the animatronic device, except for an external camera, which would be required in this embodiment. In another embodiment, the camera can be connected to onboard microcontroller 702. In another embodiment, the camera is directly interface with the external computing system 706.

In yet another embodiment, the external computing system 706 can be located on a remote server (e.g., internet). In one embodiment the external computing system 706 can be a dedicated web based server. In such an embodiment, onboard microcontroller system 702 is connected to a selected Cloud computing unit via a Wi-Fi (802.3) wireless link, and the animatronic device is managed from the external cloud computing unit. In this embodiment, the microcontroller acts as slave processor to the external (cloud) computing unit 706. The selected could computing unit 706 controls the animatronic device using software applications or mobile applications. In one embodiment, the software applications controlled by the external (cloud) computing system 706 includes face recognition as well as a speech recognition and speech to text to speech assistance. Other aspects of the embodiment using such cloud computing remain similar to as discussed using various other embodiments herein. Further, any embodiment of the animatronic device can use a combination of any technology/techniques disclosed herein.

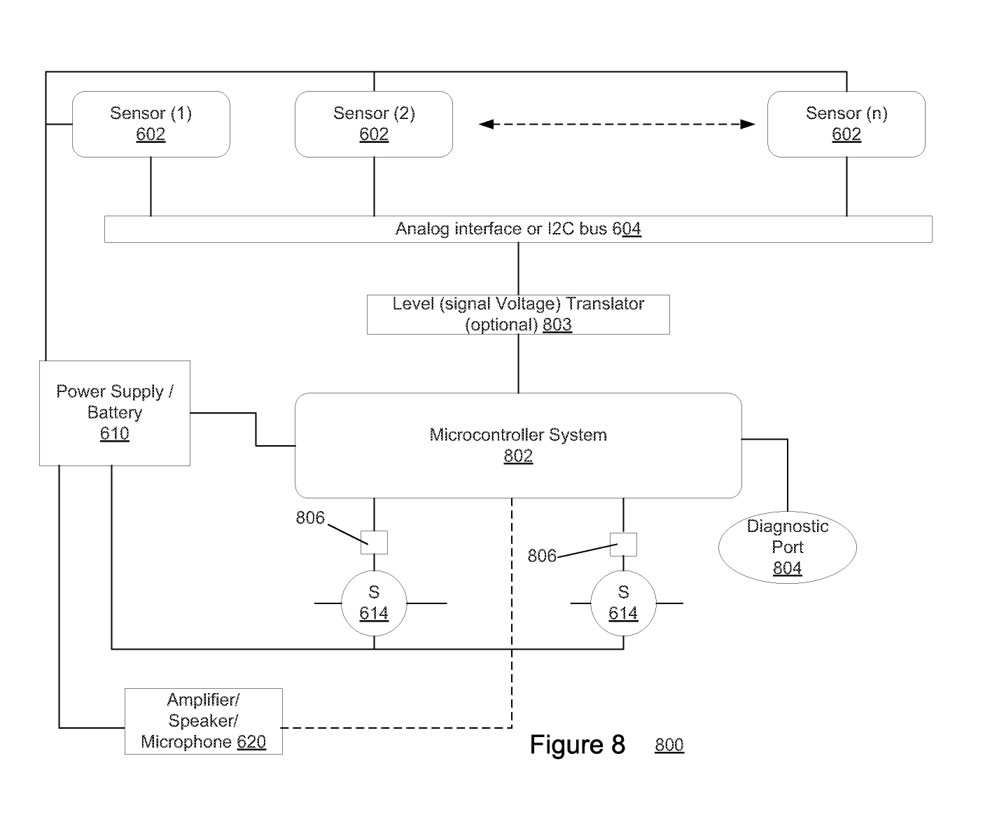

FIG. 8 illustrates the system architecture of the animatronic device, according to an embodiment of the present invention using an external computing system. As illustrated in FIG. 7, here the computing system is located externally to the animatronic device. In one embodiment, sensors 602 are interfaced to the microcontroller 802 via a digital I2C (or I2C) bus 604. In another embodiment, sensors 602 are connected to microcontroller 802 via an analog interface 604. Thus, interface 604 can be a digital or analog interface depending on the connection of the sensors to interface 604. In one embodiment, both of these sensor interfacing techniques can coexist in an animatronic device, such that some sensors may be supported over the digital I2C bus while some other sensors may be connected over analog interfaces at the same time. Diagnostic port 804 is provided for diagnosis of the system, when needed. A signal voltage level translator 803 can be needed if there is a signal levels mismatch between sensors 602 and the microcontroller 802. In any embodiment, the sensors purpose and operation can be the same as described in other embodiments, herein.

As illustrated in FIG. 8, microcontroller 802 configures some of its input and output (I/O) lines as Pulse Width Modulation signals (PWM) 806 to control servo(s) 614 operation(s). The external processing system commands microcontroller 802 to execute any needed mechanical movements. Microcontroller 802 translates and implements appropriate actions (such as generating PWM signals) to operate servo(s) 614 for mechanical movements.

In one embodiment, an external audio board with an amplifier 620 and a CODEC (Encoder and Decoder) supports the device's audio communication. The encoded data (audio) can stream through microcontroller 802, over the wireless link, to the external processing system 706 (e.g. Smartphone, cloud computing unit, etc.).

In one embodiment, the external processing system, aided by the microcontroller, handles all the system management tasks. It interprets the command and also takes into consideration any sensory data from the sensors for decision making. The external processing system decides if it can act on its own or the particular instance requires assistance from the web or rather specifically from the web based cloud computing servers. If such ‘cloud assist’ feature is utilized, then the external processing system gets the required data and suggested response from the servers. In either case, the external processing system ultimately decides on the audio and mechanical responses that are transmitted to the built-in microcontroller system 802. In one embodiment, commands for the mechanical movements from the external processing system are transmitted to the microcontroller system. In another embodiment, the external processing system only transmits the audio responses, and the mechanical movements of the animatronic device are controlled by the microcontroller system. In one embodiment, responses can either be verbal or some other sort of audio (e.g. sound) or selected magnetic actuator/servomotor instigation to execute the required movements, or a combination thereof.

The techniques shown in the figures can be implemented using computer program instructions (computer code) and data stored and executed on one or more electronic systems (e.g., computer systems, etc.). Such electronic systems store and communicate (internally and/or with other electronic systems over a network) code and data using machine-readable media, such as machine-readable non-transitory storage media (e.g., magnetic disks; optical disks; random access memory; dynamic random access memory; read only memory; flash memory devices; phase-change memory). In addition, such electronic systems typically include a set of one or more processors coupled to one or more other components, such as one or more storage devices, user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device.

It should be apparent from this description that aspects of the present invention may be embodied, at least in part, in software. That is, the techniques may be carried out in a computer system or other computer system in response to its processor, such as a microprocessor, executing sequences of instructions contained in memory, such as a ROM, DRAM, mass storage, or a remote storage device. In various embodiments, hardware circuitry may be used in combination with software instructions to implement the present invention. Thus, the techniques are not limited to any specific combination of hardware circuitry and software nor to any particular source for the instructions executed by the computer system. In addition, throughout this description, various functions and operations are described as being performed by or caused by software code to simplify description. However, those skilled in the art will recognize what is meant by such expressions is that the functions result from execution of the code by a processor.

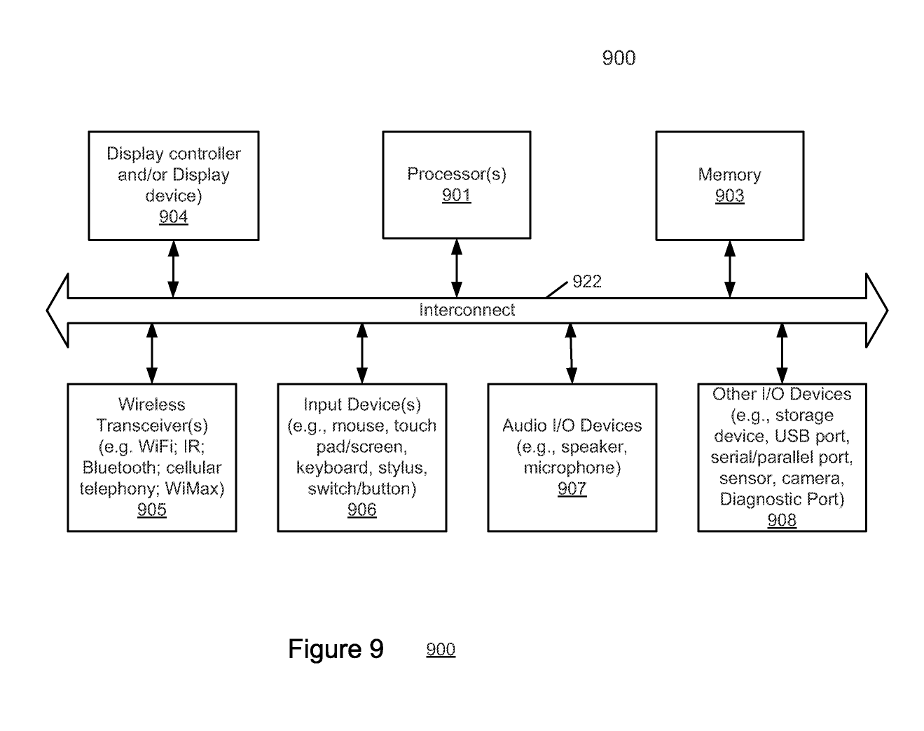

FIG. 9 is a block diagram illustrating a data processing system such as a computing system 900 which may be used with one embodiment of the invention. For example, system 900 may be implemented as part of an animatronic device. In one embodiment, system 900 may represent at least one of servo controller 602, Smartphone/tablet 302, or microcontroller system 802. System 900 may have a distributed architecture having dispersed units coupled through a network, or all of its components may be integrated into a single unit. Computing system 900 may be implemented as part of a diverse range of products implemented by Pecoto Inc.

For example, computing system 900 may represent any of data processing systems described above performing any of the processes or methods described above. System 900 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 900 is intended to show a high level view of many components of the computer system. However, it is to be understood that additional or fewer components may be present in certain implementations and furthermore, different arrangement of the components shown may occur in other implementations. System 900 may represent a desktop, a laptop, a tablet, a server, a mobile phone, a programmable logic controller, a personal digital assistant (PDA), a personal communicator, a network router or hub, a wireless access point (AP) or repeater, a set-top box, or a combination thereof.

In one embodiment, system 900 includes processor 901, memory 903, and devices 905-908 via a bus or an interconnect 922. Processor 901 may represent a single processor or multiple processors with a single processor core or multiple processor cores included therein. Processor 901 may represent one or more general-purpose processors such as a microprocessor, a central processing unit (CPU), or the like. More particularly, processor 901 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 901 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 901, which may be a low power multi-core processor socket such as an ultra low voltage processor, may act as a main processing unit and central hub for communication with the various components of the system. Such processor can be implemented as a system on chip (SoC). In one embodiment, processor 901 may be an Intel® Architecture Core™-based processor such as an i3, i5, i7 or another such processor available from Intel Corporation, Santa Clara, Calif. However, other low power processors such as available from Advanced Micro Devices, Inc. (AMD) of Sunnyvale, Calif., an ARM-based design from ARM Holdings, Ltd. or a MIPS-based design from MIPS Technologies, Inc. of Sunnyvale, Calif., or their licensees or adopters may instead be present in other embodiments.

Processor 901 is configured to execute instructions for performing the operations and methods discussed herein. System 900 further includes a graphics interface that communicates with graphics subsystem 904, which may include a display controller and/or a display device.

Processor 901 may communicate with memory 903, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 207-2E (published April 2007), or a next generation LPDDR standard to be referred to as LPDDR3 that will offer extensions to LPDDR2 to increase bandwidth. As examples, 2/4/8 gigabytes (GB) of system memory may be present and can be coupled to processor 901 via one or more memory interconnects. In various implementations the individual memory devices can be of different package types such as single die package (SDP), dual die package (DDP) or quad die package (QDP). These devices can in some embodiments be directly soldered onto a motherboard to provide a lower profile solution, while in other embodiments the devices can be configured as one or more memory modules that in turn can couple to the motherboard by a given connector.

Memory 903 can be a machine readable non-transitory storage medium such as one or more volatile storage (or memory) devices such as random access memory (RAM), dynamic RAM (DRAM), synchronous DRAM (SDRAM), static RAM (SRAM), or other types of storage devices such as hard drives and flash memory. Memory 903 may store information including sequences of executable program instructions that are executed by processor 901, or any other device. For example, executable code and/or data of a variety of operating systems, device drivers, firmware (e.g., input output basic system or BIOS), and/or applications can be loaded in memory 903 and executed by processor 901. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 900 may further include IO devices such as devices 905-908, including wireless transceiver(s) 905, input device(s) 906, audio IO device(s) 907, and other IO devices 908. Wireless transceiver 905 may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, network interfaces (e.g., Ethernet interfaces) or a combination thereof.

Input device(s) 906 may include a mouse, a touch pad, a touch sensitive screen (which may be integrated with display device 904), a pointer device such as a stylus, and/or a keyboard (e.g., physical keyboard or a virtual keyboard displayed as part of a touch sensitive screen). For example, input device 906 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO device 907 may include a speaker and/or a microphone and/or Codec to facilitate voice-enabled functions, such as voice recognition, voice replication, digital recording, and/or telephony functions. In hardware, in one embodiment, an audio codec can refer to a device(s) that encodes analog audio as digital signals and decodes digital back into analog. In one embodiment, Audio IO device 907 comprises an Analog-to-digital converter (ADC), a Digital-to-analog converter (DAC), or a combination thereof, running off the same clock. Other optional devices 908 may include a storage device (e.g., a hard drive, a flash memory device), universal serial bus (USB) port(s), parallel port(s), serial port(s), diagnostic port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Optional devices 908 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 907 via a sensor hub (not shown), while other devices such as a keyboard or thermal sensor may be controlled by an embedded controller (not shown), dependent upon the specific configuration or design of system 900.

To provide for persistent storage of information such as data, applications, one or more operating systems and so forth, a mass storage (not shown) may also couple to processor 901. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on RE-initiation of system activities. Also a flash device may be coupled to processor 901, e.g., via a serial peripheral interface (SPI). This flash device may provide for non-volatile storage of system software, including a basic input/output software (BIOS) as well as other firmware of the system.

Note that while system 900 is illustrated with various components of a data processing system, it is not intended to represent any particular architecture or manner of interconnecting the components; as such details are not germane to embodiments of the present invention. It will also be appreciated that network computers, handheld computers, mobile phones, and other data processing systems which have fewer components or perhaps more components may also be used with embodiments of the invention.

Thus, methods, devices, and computer readable medium to control and interact with an electronic (animatronic) toy are disclosed. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. An animatronic device configured as a stuffed toy, the animatronic device comprising:
a plurality of sensors, wherein the plurality of sensors includes at least an audio sensor, a visual sensor, a proximity sensor, olfactory sensor, and a touch sensor,
an audio transmitting module;
a moveable appendage located on a face portion of the stuffed toy, wherein the movable appendage is configured to imitate a lip like structure;
at least one actuator, coupled to the moveable appendage, wherein the actuator can control mechanical movements of the moveable appendage;
a memory module;
a first data processing unit coupled to the memory module, the first data processing unit including at least one processor, wherein the first data processing unit is configured to:
receive a signal from at least one of the plurality of sensors of the animatronic device, wherein the signal is generated due to at least one of a verbal, visual, proximity based, touch based, or odor based command;
process the signal to generate an instruction;
transmit the instruction to a second data processing unit;
receive a response from the second data processing unit, wherein the response includes an audible transmission;
and based on the response, control the at least one actuator, wherein the at least one actuator generates mechanical movements in the moveable appendage.

2. The animatronic device of claim 1, wherein the second data processing unit is located in a Smartphone.

3. The animatronic device of claim 2, wherein the Smartphone is enclosed within the animatronic device, and wherein at least one of the plurality of sensors is located inside the Smartphone, and wherein the second data processing unit communicates with the first data processing unit via a micro-Universal Serial Bus (micro-USB) interface located on the Smartphone.

4. The animatronic device of claim 1, wherein the plurality of sensors further includes a gyroscope, an air pressure sensor, an orientation sensor, a geo-location sensor, and a temperature sensor.

5. The animatronic device of claim 1, wherein the proximity sensor is at least one of an infrared sensor or an ultrasound sensor.

6. The animatronic device of claim 1, wherein the first data processing unit synchronizes an audio transmission, via the audio transmitting module, along with the mechanical movements of the moveable appendage by the at least one actuator.

7. The animatronic device of claim 1, wherein the second data processing unit synchronizes an audio transmission, via the audio transmitting module, along with the mechanical movements of the moveable appendage by the at least one actuator.

8. The animatronic device of claim 1, wherein the second data processing unit is further configured to:
based on the signal received from the first data processing unit, transmit another instruction, over a computer network, to a third data processing unit;
receive the response from the third data processing unit; and
transmit the response to the first data processing unit.

9. The animatronic device of claim 1, wherein the first data processing unit and the second data processing unit communicate using a wireless communication protocol.

10. The animatronic device of claim 1, wherein the second data processing unit is located on a remote network.

11. The animatronic device of claim 1, wherein the at least one actuator is a servomotor.

12. The animatronic device of claim 1 further comprising:
at least another actuator to provide head movement and arm movement of the stuffed toy.

13. A non-transitory computer readable medium comprising instructions which when executed by a processing system having at least one processor of an electronic toy executes a method, the method comprising:
receiving, by the processing system of the electronic toy, a signal generated by at least one of a plurality of sensors located inside the electronic toy, wherein the plurality of sensors includes at least one of an audio sensor, a visual sensor, a proximity sensor, olfactory sensor, or a touch sensor, and wherein the signal is generated due to at least one of a verbal, visual, proximity based, touch based, or odor based command;
processing the signal to generate an instruction;
transmitting the instruction to a computing device; and
receiving a response from the computing device, wherein the response includes a verbal communication from the computing device;
based on the response, controlling at least one actuator by the processing system of the electronic toy, and wherein at least one actuator located in the electronic device is instructed by the processing system to generate mechanical movements in a moveable appendage of the electronic device, wherein the moveable appendage is located on a face portion of the electronic toy, and wherein the movable appendage is configured to imitate a lip like structure, and wherein the at least one actuator is coupled to the moveable appendage.

14. The non-transitory computer readable medium of claim 13, wherein the computing device is a Smartphone.

15. The non-transitory computer readable medium of claim 14, wherein the Smartphone is enclosed within the animatronic device, and wherein at least one of the plurality of sensors is located inside the Smartphone, and wherein the Smartphone communicates with the first data processing unit via a micro-Universal Serial Bus (micro-USB) interface located on the Smartphone.

16. The non-transitory computer readable medium of claim 13, wherein the plurality of sensors further includes a gyroscope, an air pressure sensor, an orientation sensor, a geo-location sensor, and a temperature sensor, and wherein the proximity sensor is at least one of an infrared sensor or an ultrasound sensor.

17. The non-transitory computer readable medium of claim 13, wherein the processing system synchronizes the controlling of the at least one actuator to the response, and wherein the response is transmitted via a audio transmitting module of the electronic device.

18. The non-transitory computer readable medium of claim 13, wherein the computing device is further configured to:
based on the instruction received from the processing system, transmit another instruction, over a computer network, to another computing system;
receive the response from the another computing system; and
transmit the response to the processing system;
wherein the another computing system is located on a cloud based computer network.

19. The non-transitory computer readable medium of claim 13, wherein the processing system and the computing device communicate using a wireless communication protocol.

20. The non-transitory computer readable medium of claim 13, wherein the at least one actuator is a servomotor, and wherein the electronic toy further comprises at least another actuator to provide head movement and arm movement of the stuffed toy.
